(19) United States
(12) Patent Application Publication
(10) Pub. No.: US 2026/0212817 A1
(43) Pub. Date: Jul. 23, 2026

(54) Display Device and Method of Driving the Same

(71) Applicant: LG Display Co., Ltd., Seoul (KR)

(72) Inventors: Ju Hee Eun, Paju-si (KR); Jin Hun Kim, Paju-si (KR); Ju Hwan Baek, Paju-si (KR); Yeon Jin Sa, Paju-si (KR)

(21) Appl. No.: 19/414,846

(22) Filed: Dec. 10, 2025

(30) Foreign Application Priority Data
Jan. 23, 2025 (KR) 10-2025-0010455

(51) Int. Cl. G09G 3/3233; G09G 3/3266

(52) U.S. Cl. CPC G09G 3/3233; G09G 3/3266; G09G 2300/0861; G09G 2310/08; G09G 2330/021; G09G 2330/028

(57) ABSTRACT

A display device includes a display panel having subpixels formed thereon, each of the subpixels including a driving transistor configured to generate a driving current for driving a light emitting element, and at least one light emission control transistor configured to apply a high-potential voltage to the driving transistor, a gate driver configured to receive a gate high voltage and a gate low voltage, and to output a gate signal for controlling the transistors included in the subpixels, and a power supply configured to supply a gate high voltage set according to a voltage level of the high-potential voltage to the gate driver.

### CROSS-REFERENCE TO RELATED APPLICATION

This application claims the benefit of Republic of Korea Patent Application No. 10-2025-0010455, filed on January 23, 2025, which is hereby incorporated in its entirety.

### TECHNICAL FIELD

The present disclosure relates to a device and particularly to, for example, without limitation, a display device and a method of driving the same.

### DISCUSSION OF THE RELATED ART

An electroluminescent display device has advantages of high response speed, high luminous efficacy, and wide viewing angle. The electroluminescent display device including a plurality of subpixels may display an image by causing a light emitting element of each subpixel to emit light.

The light emitting element may be implemented based on an organic or inorganic material. The display device may include a display panel including a plurality of subpixels, a driving unit configured to output a driving signal for driving the display panel, and a power supply configured to generate power to be supplied to the display panel and the driving unit.

Various technologies have been applied to such a display device to reduce power consumption. However, since the previously proposed methods have room for improvement, research has been continuing to increase a power consumption reduction effect while maintaining performance of a panel.

### SUMMARY

Accordingly, the present disclosure is directed to a display device and a method of driving the same that substantially obviate one or more problems due to limitations and disadvantages of the related art.

Therefore, the present disclosure provides a display device and a method of driving the same capable of improving or maximizing the power consumption reduction effect.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a display device includes a display panel having subpixels formed thereon, each of the subpixels including a driving transistor configured to generate a driving current for driving a light emitting element, and at least one light emission control transistor configured to apply a high-potential voltage to the driving transistor, a gate driver configured to receive a gate high voltage and a gate low voltage, and to output a gate signal for controlling the transistors included in the subpixels, and a power supply configured to supply a gate high voltage set according to a voltage level of the high-potential voltage to the gate driver.

A difference between the high-potential voltage and the gate high voltage may be maintained constant based on an offset value.

The display device may further include a memory configured to store the offset value and high-potential voltage setting information per luminance of image data.

The display device may further include a controller configured to generate luminance information of the image data, and a data driver configured to receive the luminance information from the controller, and to control the power supply so that a high-potential voltage corresponding to the luminance information is output according to the high-potential voltage setting information per luminance stored in the memory.

The data driver may set the gate high voltage by applying the offset value to the high-potential voltage corresponding to the luminance information, and control the power supply so that the set gate high voltage is supplied to the data driver.

The one of the at least one light emission control transistor may include a gate electrode configured to receive the gate signal, a first electrode configured to receive the high-potential voltage, and a second electrode connected to a source electrode of the driving transistor.

The at least one light emission control transistor may include a P-type thin film transistor.

The at least one light emission control transistor may be turned off by receiving the gate high voltage of the gate signal.

The offset value is set based on a positive offset value greater than a threshold voltage of the at least one light emission control transistor and the high-potential voltage.

In another aspect of the present disclosure, a method of driving a display device including a display panel having subpixels formed thereon, each of the subpixels including a driving transistor configured to generate a driving current for driving a light emitting element, and at least one light emission control transistor configured to apply a high-potential voltage to the driving transistor, includes setting a voltage level of the high-potential voltage according to input image luminance, setting a level of a gate high voltage by applying a preset offset value to a voltage level of the high-potential voltage, and generating an emission control signal that swings between the gate high voltage and a gate low voltage to output the generated emission control signal to the display panel.

One of the at least one light emission control transistor may include a gate electrode configured to receive the gate signal, a first electrode configured to receive the high-potential voltage, and a second electrode connected to a source electrode of the driving transistor.

The at least one light emission control transistor may include a P-type thin film transistor.

Setting the level of the gate high voltage may include setting a voltage level of the gate high voltage so that a voltage difference between the high-potential voltage and the gate high voltage is set to a voltage level allowing the one light emission control transistor to be turned off.

The offset value is set based on a positive offset value greater than a threshold voltage of the at least one light emission control transistor and the high-potential voltage.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with embodiments of the disclosure.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a schematic block diagram of a display device according to an embodiment of the present disclosure;

FIG. 2 is a diagram illustrating a circuit diagram of a subpixel included in the display device of FIG. 1 and a current flow in each driving period according to an embodiment of the present disclosure;

FIG. 3 is a waveform diagram of a scan signal and an emission control signal of the subpixel of FIG. 2 according to an embodiment of the present disclosure;

FIG. 4 is a diagram for describing matters to be considered for variably controlling a high-potential voltage EVDD and a gate high voltage VGH in the subpixel of FIG. 2 according to an embodiment of the present disclosure;

FIG. 5 is a schematic configuration diagram of an optical compensation system applied to the display device according to an embodiment of the present disclosure;

FIG. 6 is a diagram for describing information on setting the high-potential voltage EVDD per luminance according to an embodiment of the present disclosure;

FIG. 7 is a flowchart of an optical compensation method applied to the display device according to an embodiment of the present disclosure;

FIG. 8 is a diagram illustrating a configuration for controlling the gate high voltage VGH of the display device according to an embodiment of the present disclosure; and

FIG. 9 is a flowchart of a method of controlling the gate high voltage VGH of the display device according to an embodiment of the present disclosure.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or may be briefly discussed. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

Advantages and features of the present disclosure and a method of achieving the advantages and features will become clear with reference to the embodiments described in detail below together with the accompanying drawings. However, the present disclosure is not limited to the embodiments disclosed below and may be implemented in various different forms, and the present embodiments are provided only to make the disclosure of the present disclosure complete and to fully inform a person having ordinary skill in the art to which the present disclosure pertain of the scope of the disclosure.

The shapes, sizes, ratios, angles, numbers, etc. disclosed in the drawings to describe the embodiments of the present disclosure are illustrative, and thus the present disclosure is not limited to the illustrated matters. The same reference numerals refer to the same components throughout the specification. When the terms “include”, “have”, and “consist of”, etc. are used in the present disclosure, other parts may be added unless “only” is used. When a component is expressed in a singular form, this includes the case where the component is plural unless there is a specifically explicit description.

When interpreting a component, the component is interpreted as including an error range even if there is no separate explicit description.

When describing a positional relationship, for example, when a positional relationship between two parts is described as “on”, “above”, “below”, “next to”, etc., one or more other parts may be located between the two parts, unless “immediately” or “directly” is used.

Even though the terms first, second, etc. may be used to describe various components, these components are not limited by these terms. These terms are only used to distinguish one component from another. Thus, a first component mentioned below may be a second component within the technical concept of the present disclosure.

Any implementation described herein as an “example” is not necessarily to be construed as preferred or advantageous over other implementations.

In describing a temporal relationship, when the temporal order is described as, for example, “after,” “subsequent,” “next,” and “before,” a case that is not continuous may be included unless a more limiting term, such as “just,” “immediate(ly),” or “direct(ly)” is used.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first element, a second element, and a third element” encompasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these embodiments may be provided so that this disclosure may be sufficiently thorough and complete to assist those skilled in the art to fully understand the scope of the present disclosure. Furthermore, the present disclosure is only defined by scopes of claims.

Features of various embodiments of the present disclosure may be partially or overall coupled to or combined with each other, and may be variously inter-operated with each other and driven technically as those skilled in the art can sufficiently understand. Embodiments of the present disclosure may be carried out independently from each other, or may be carried out together in co-dependent relationship.

In addition, a pixel circuit and a gate driver of a display device described below may include a plurality of transistors. The transistors may be implemented as an oxide thin film transistor (TFT) including an oxide semiconductor, an LTPS TFT including low temperature poly silicon (LTPS), etc. Each of the transistors may be implemented as a p-channel TFT or an n-channel TFT.

A transistor is a three-electrode device that includes a gate, a source, and a drain. The source is an electrode that supplies carriers to the transistor. Inside the transistor, carriers start to flow from the source. The drain is an electrode through which carriers exit the transistor. In the transistor, carriers flow from the source to the drain. In the case of an n-channel transistor, since the carriers are electrons, a source voltage is lower than a drain voltage so that electrons may flow from the source to the drain. In the n-channel transistor, current flows in a direction from the drain to the source. In the case of a p-channel transistor (PMOS), since the carriers are holes, the source voltage is higher than the drain voltage so that the holes may flow from the source to the drain. In the p-channel transistor, since holes flow from the source to the drain, current flows from the source to the drain. It should be noted that the source and the drain of the transistor are not fixed. For example, the source and the drain may be changed depending on the applied voltage. Therefore, the disclosure is not limited by the source and the drain of the transistor. In the following description, the source and the drain of the transistor will be referred to as first and second electrodes.

A gate signal swings between a gate-on-voltage and a gate-off-voltage. The gate-on-voltage is set to a voltage higher than a threshold voltage of the transistor, and the gate-off-voltage is set to a voltage lower than the threshold voltage of the transistor. The transistor turns on in response to the gate-on-voltage, and turns off in response to the gate-off-voltage. In the n-channel transistor, the gate-on-voltage may be a gate-high-voltage (VGH), and the gate-off-voltage may be a gate-low-voltage (VGL). In the p-channel transistor, the gate-on-voltage may be a VGL, and the gate-off-voltage may be a VGH.

Each pixel of an electroluminescent display device includes a light emitting element and a driving element that generates pixel current according to a voltage between a gate and a source to drive the light emitting element. The light emitting element includes an anode, a cathode, and an organic compound layer formed therebetween. The organic compound layer may include, but is not limited to, a hole injection layer (HIL), a hole transport layer (HTL), an emission layer (EML), an electron transport layer (ETL), an electron injection layer (EIL), etc. When a pixel current flows in the light emitting element, holes passing through the HTL and electrons passing through the ETL move to the EML, thereby forming excitons, and as a result, the EML may emit visible light.

Throughout the specification, the same reference numerals refer to substantially the same components. Hereinafter, embodiments of the present disclosure will be described in detail with reference to the attached drawings. In the following description, when it is determined that a detailed description of a known function or configuration related to the present disclosure may unnecessarily obscure the gist of the present disclosure, the detailed description will be omitted.

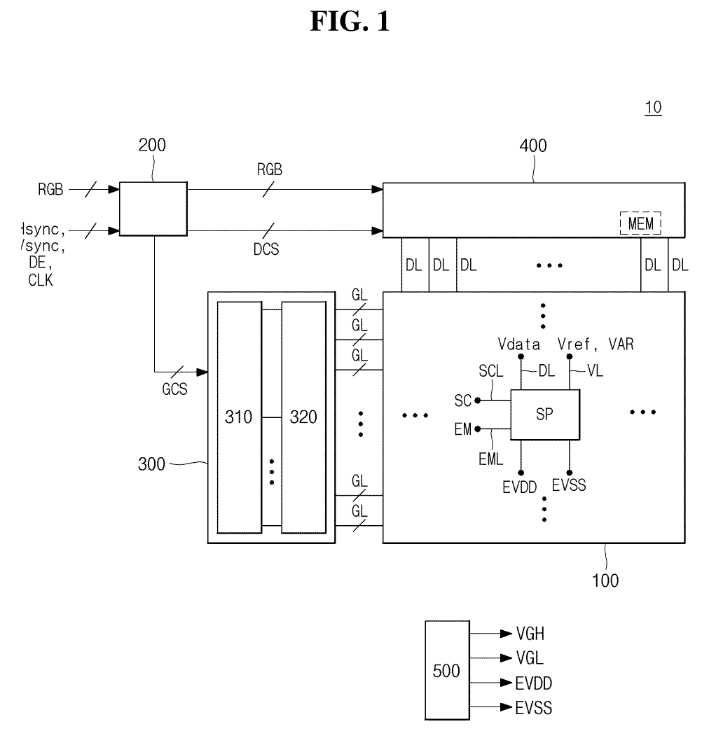

FIG. 1 is a block diagram schematically illustrating a display device according to an embodiment of the present disclosure.

Referring to FIG. 1, the display device 10 includes a display panel 100 including a plurality of subpixels SP, a controller 200, a gate driver 300 configured to supply a gate signal to each of the plurality of subpixels SP, a data driver 400 configured to supply a data signal to each of the plurality of subpixels SP, and a power supply 500 configured to supply power required for driving to each of the plurality of subpixels SP.

The display panel 100 has a plurality of gate lines GL and a plurality of data lines DL that intersect each other, and each of the plurality of subpixels SP is connected to a gate line GL and a data line DL. Specifically, one subpixel SP receives a gate signal from the gate driver 300 through the gate line GL, receives a data signal from the data driver 400 through the data line DL, and receives a high-potential voltage EVDD and a low-potential voltage EVSS from the power supply 500.

Here, the gate line GL supplies a gate signal, and the data line DL supplies a data voltage signal Vdata. The gate signal may include a scan signal SC and an emission control signal EM. Accordingly, the gate line GL may include a plurality of scan lines SCL that supply a scan signal SC and an emission control signal line EML that supplies an emission control signal EM. In addition, each of the plurality of subpixels SP may additionally include a power line VL to receive an anode reset voltage VAR, an initialization voltage Vref, etc.

The controller 200 processes image data RGB input from a host system appropriately for the size and resolution of the display panel 100 and supplies the image data to the data driver 400. The controller 200 may analyze luminance of the input image data RGB and provide luminance band information of the corresponding image to the data driver 400.

The host system may be one of a TV Television system, a set-top box, a navigation system, a personal computer PC, a home theater system, a mobile device, a wearable device, and a vehicle system.

The controller 200 generates a gate control signal GCS for controlling operation timing of the gate driver 300 and a data control signal DSC for controlling operation timing of the data driver 400 based on timing signals Vsync, Hsync, and DE received from the host system.

The gate driver 300 may be arranged on one side or both sides of the display panel 100 in a GIP (Gate-In-Panel) manner. The gate driver 300 may sequentially output a gate signal to the gate line GL according to the gate control signal GCS supplied from the controller 200. The gate signal may include a scan signal SC and an emission control signal EM in an organic light emitting display device. Accordingly, the gate driver 300 may include an emission control signal driver 310 that outputs the emission control signal EM and a scan driver 320 that outputs the scan signal SC.

The scan signal SC and the emission control signal EM output from the gate driver 300 may include pulses that swing between a gate low voltage VGL and the gate high voltage VGH. In the embodiment of the present disclosure, a voltage level of the gate high voltage VGH of each of the scan signal SC and the emission control signal EM may be set to vary according to a voltage level of the high-potential voltage EVDD.

The data driver 400 may convert image data RGB into a data voltage signal Vdata according to the data control signal DCS supplied from the controller 200, and supply the converted data voltage signal Vdata to a subpixel SP through the data line DL. The data driver 400 may include a plurality of integrated circuits ICs and may be arranged in a plurality of separate sections on one side of the display panel 100.

The data driver 400 according to the embodiment of the present disclosure may include a memory MEM that stores gate high voltage VGH setting information and high-potential voltage EVDD setting information according to luminance of the image data RGB. The memory MEM may store high-potential voltage EVDD setting information according to the grayscale (Gray) of the image data RGB. In addition, gate high voltage VGH setting information for setting the gate high voltage VGH based on a voltage level of the high-potential voltage EVDD may be stored. The gate high voltage VGH setting information may be stored as an offset value added to the high-potential voltage EVDD. The high-potential voltage EVDD setting information and the gate high voltage VGH setting information stored in the memory MEM may be stored during optical compensation of the display device 10. A storage process and an application method of the high-potential voltage EVDD setting information and the gate high voltage VGH setting information stored in the memory MEM will be described in more detail later in the description.

The power supply 500 may receive a DC input voltage applied from the outside to generate DC voltages such as the gate low voltage VGL, the gate high voltage VGH, the high-potential voltage EVDD, and the low-potential voltage EVSS.

The power supply 500 generates DC power required to drive a pixel array of the display panel 100 and a display panel driver using a DC-DC converter. The DC-DC converter may include a charge pump, a regulator, a buck converter, a boost converter, etc.

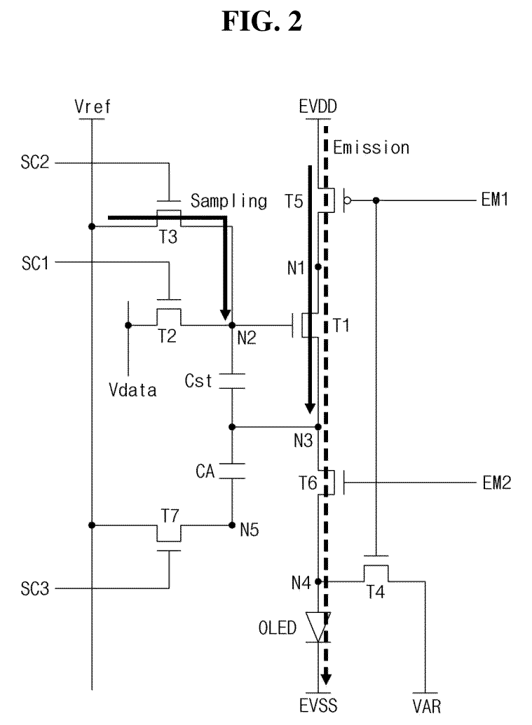

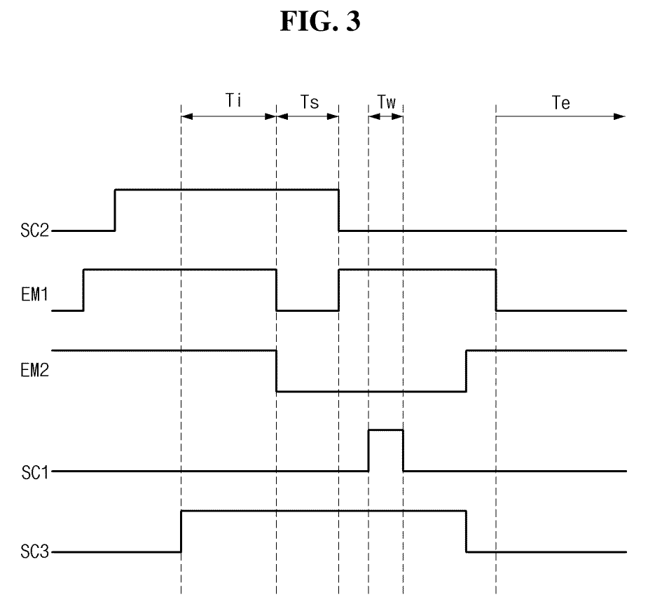

FIG. 2 is a diagram illustrating a circuit diagram of the subpixel included in the display device of FIG. 1 and a current flow in each driving period, and FIG. 3 is a waveform diagram of the scan signal and the emission control signal of the subpixel of FIG. 2.

Referring to FIG. 2, one subpixel SP may be supplied with the high-potential voltage EVDD, the low-potential voltage EVSS, an initialization voltage Vref, and an anode reset voltage VAR, and may receive first to third scan signals SC1 to SC3, first and second emission control signals EM1 and EM2, and a data voltage signal Vdata.

One subpixel SP may include an organic light emitting diode (OLED), seven transistors T1 to T7, and two capacitors Cst and CA. Each of the transistors T1 to T7 of the subpixel SP may be configured as a p-type MOSFET (PMOS) or an n-type MOSFET (NMOS). In this embodiment, the fifth transistor T5 is implemented as a p-type, and each of the remaining transistors T1 to T4, and T6 to T7 are implemented as an n-type. Therefore, the fifth transistor T5 turns on when a low voltage is applied to a gate electrode, and each of the remaining transistors T1 to T4, and T6 to T7 turns on when a high voltage is applied to a gate electrode.

The OLED emits light by a driving current supplied from the first transistor T1. An anode of the OLED may be connected to a fourth node N4, and a cathode of the OLED may be connected to a wire to which the low-potential voltage EVSS is provided.

The first transistor T1 may correspond to a driving transistor. The first transistor T1 may have a gate electrode connected to a second node N2, a first electrode connected to a first node N1, and a second electrode connected to a third node N3. The first transistor T1 may generate a driving current supplied to the OLED based on a voltage of the second node N2.

The second transistor T2 may be turned on in response to a first scan signal SC1. When the first scan signal SC1 is applied at a high level, the second transistor T2 is turned on and applies the data voltage signal Vdata to the second node N2, which is the gate electrode of the first transistor T1. The second transistor T2 may include a gate electrode connected to an input line of the first scan signal SC1, a first electrode connected to a data line to which the data voltage signal Vdata is supplied, and a second electrode connected to the second node N2. The second transistor T2 may be a data supply transistor.

The third transistor T3 may be turned on in response to a second scan signal SC2. When the second scan signal SC2 is applied at a high level, the third transistor T3 is turned on and applies the initialization voltage Vref to the second node N2 of the first transistor T1. The third transistor T3 may include a gate electrode connected to an input line of the second scan signal SC2, a first electrode connected to a power line of the initialization voltage Vref, and a second electrode connected to the second node N2.

The fourth transistor T4 may be turned on in response to a first emission control signal EM1. The fourth transistor T4 is turned on when the first emission control signal EM1 is input at a high level, and applies the anode reset voltage VAR to the fourth node N4 to which the anode of the OLED is connected. The fourth transistor T4 may include a gate electrode connected to an input line of the first emission control signal EM1, a first electrode connected to a power line of the anode reset voltage VAR, and a second electrode connected to the fourth node N4.

The fifth transistor T5 may be turned on in response to the first emission control signal EM1. The fifth transistor T5 is turned on when the first emission control signal EM1 is input at a low level, and may transmit the high-potential voltage EVDD to the first node N1 of the first transistor T1. The fifth transistor T5 may include a gate electrode connected to the input line of the first emission control signal EM1, a first electrode connected to a power line of the high-potential voltage EVDD, and a second electrode connected to the first node N1.

The sixth transistor T6 may be turned on in response to the second emission control signal EM2. The sixth transistor T6 may be turned on when the second emission control signal EM2 is input at a high level, and may connect the third node N3 of the first transistor T1 and the fourth node N4 of the OLED. The sixth transistor T6 may include a gate electrode connected to an input line of the second emission control signal EM2, a first electrode connected to the third node N3, and a second electrode connected to the fourth node N4.

The seventh transistor T7 may be turned on in response to a third scan signal SC3. The seventh transistor T7 is turned on when the third scan signal SC3 is applied at a high level, and applies the initialization voltage Vref to a fifth node N5. The seventh transistor T7 may include a gate electrode connected to an input line of the third scan signal SC3, a first electrode connected to the power line of the initialization voltage Vref, and a second electrode connected to the fifth node N5.

The first capacitor Cst may correspond to a storage capacitor Cst. The first capacitor Cst may be connected between the second node N2 of the first transistor T1 and the third node N3 of the first transistor T1. The first capacitor Cst may include a first electrode corresponding to the second node N2 and a second electrode corresponding to the third node N3.

The second capacitor CA may be connected between the third node N3 of the first transistor T1 and the fifth node N5 to which the seventh transistor T7 is connected. The second capacitor CA may include a first electrode corresponding to the third node N3 and a second electrode corresponding to the fifth node N5.

FIG. 3 is a waveform diagram of the scan signal and the emission control signal of the subpixel of FIG. 2. Referring to FIG. 3, a driving period of the subpixel may include an initialization period Ti, a sampling period Ts, a data writing period Tw, and an emission period Te.

Referring to FIGS. 2 and 3, during the initialization period Ti, the first scan signal SC1 is input at a low level, and the second and third scan signals SC2 and SC3 and the first and second emission control signals EM1 and EM2 are each input at a high level. Accordingly, the second transistor T2 and the fifth transistor T5 are turned off, and the third and fourth transistors T3 and T4, and the sixth and seventh transistors T6 and T7 are turned on.

As the third and seventh transistors T3 and T7 are turned on, the second node N2 and the third node N3 of the first transistor T1 may be initialized to the initialization voltage Vref. As the fourth transistor T4 is turned on, the fourth node N4 connected to the anode of the OLED may be reset to the anode reset voltage VAR.

During the sampling period Ts, the second and third scan signals SC2 and SC3 are each input at a high level. The first scan signal SC1 and the first and second emission control signals EM1 and EM2 are each input at a low level. Accordingly, the third and seventh transistors T3 and T7 and the fifth transistor T5 are turned on, and the second transistor T2 and the fourth and sixth transistors T4 and T6 are turned off.

As the third transistor T3 is turned on, the initialization voltage Vref is applied to the second node N2 of the first transistor T1, and as the seventh transistor T7 is turned on, the initialization voltage Vref is applied to the fifth node N5.

As the fifth transistor T5 is turned on, the high-potential voltage EVDD is applied to the first node of the first transistor T1. Since the sixth transistor T6 is turned off, current flows from the first node to the third node of the first transistor T1, and a voltage of the third node rises to a level of a threshold voltage Vth of the first transistor T1, so that the threshold voltage Vth may be sampled. After the threshold voltage Vth is sampled, when the first emission control signal EM1 is switched to a high level and the fifth transistor T5 is turned off, supply of the high-potential voltage EVDD is cut off. When the second scan signal SC2 is switched to a low level and the third transistor T3 is turned off, a voltage difference between the second node and the third node, i.e., the threshold voltage Vth, may be sampled in the first capacitor Cst and the second capacitor CA.

During the data writing period Tw, the second scan signal SC2 and the second emission control signal EM2 are each input at a low level, and the first and third scan signals SC1 and SC3 and the first emission control signal EM1 are each input at a high level. Accordingly, the second transistor T2, the fourth transistor T4, and the seventh transistor T7 are turned on, and the third transistor T3, and the fifth and sixth transistors T5 and T6 are turned off.

As the second transistor T2 is turned on, the data voltage signal Vdata may be applied to the second node N2. The data voltage signal Vdata applied to the second node N2 is compensated by the sampled threshold voltage Vth, and a data voltage compensated by the threshold voltage Vth may be stored in the first capacitor Cst and the second capacitor CA.

During the emission period Te, the first to third scan signals SC1, SC2, and SC3 and the first emission control signal EM1 are each input at a low level, and the second emission control signal EM2 is input at a high level.

As the first emission control signal EM1 is input at a low level, the fifth transistor T5 is turned on, and as the second emission control signal EM2 is input at a high level, the sixth transistor T6 is turned on. The second to fourth transistors T2, T3, and T4 and the seventh transistor T7 are turned off.

As the fifth transistor T5 and the sixth transistor T6 are simultaneously turned on, the first electrode of the first transistor T1 may be connected to the high-potential voltage EVDD and the third electrode may be connected to the anode of the OLED. Accordingly, the first transistor T1 may apply a driving current corresponding to a data voltage compensated by the threshold voltage Vth to the OLED to cause the OLED to emit light.

In the display device including such a subpixel SP, power consumption may be reduced by variably controlling the voltage level of the high-potential voltage EVDD according to the luminance of the input image. In addition, by variably setting the gate high voltage VGH of the gate signal based on the variably set high-potential voltage EVDD, unnecessary power consumption for driving the subpixel may be prevented, thereby maximizing the power consumption reduction effect.

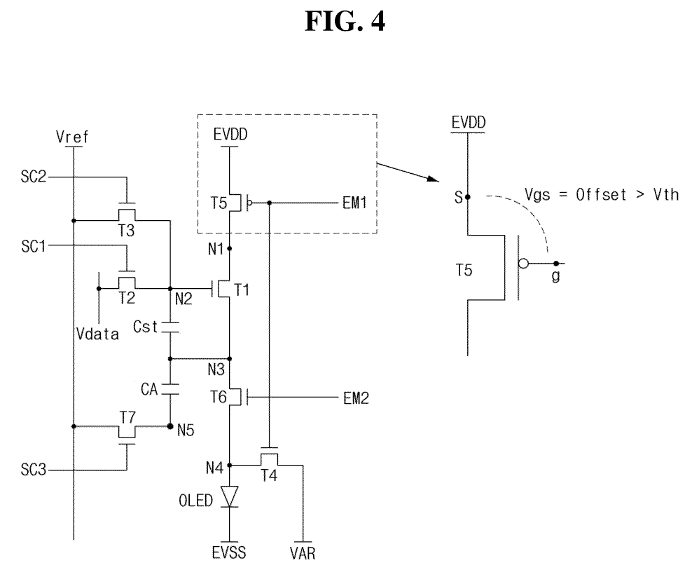

FIG. 4 is a diagram for describing matters to be considered for variably controlling the high-potential voltage EVDD and the gate high voltage VGH.

As described with reference to FIG. 1, the gate driver 300 (see FIG. 1) outputs gate signals SC and EM. The gate signals SC and EM include a scan pulse that swings between the gate low voltage VGL and the gate high voltage VGH. A transistor is turned on in response to a gate-on voltage of a gate signal and turned off in response to a gate-off voltage.

Since the fifth transistor T5 connected to the variably set high-potential voltage EVDD is a p-channel transistor, the gate-on voltage may be the gate low voltage VGL and the gate-off voltage may be the gate high voltage VGH. When the gate high voltage VGH is adjusted to reduce power, a voltage level of the gate high voltage VGH needs to be set to a voltage level that may turn off the fifth transistor T5, which is a p-channel transistor. Since an off state may be maintained when a voltage difference between the gate electrode g and the source electrode s is lower than the threshold voltage Vth, the fifth transistor T5, which is a p-channel transistor, may be maintained in the off state when a voltage of the gate electrode g is higher than EVDD + Vth. Therefore, by setting an offset value greater than the threshold voltage Vth and applying an offset value to the variable high-potential voltage EVDD to set the gate high voltage VGH, the fifth transistor T5, which is a p-channel transistor, may be maintained in the off state without using an unnecessarily high voltage.

As described according to the above embodiment, the display device sets an offset value greater than the threshold voltage Vth of the fifth transistor T5, which is a p-channel transistor, and sets the voltage level of the gate high voltage VGH by applying the offset value based on the high-potential voltage EVDD, thereby maintaining a voltage level difference between the high-potential voltage EVDD and the gate high voltage VGH constant within a range that keeps the fifth transistor T5 in the off state. As a result, the fifth transistor T5, which is a p-channel transistor, may be kept in the off state without using an excessively high voltage, thereby improving power efficiency.

The display device according to the embodiment of the present disclosure may include the memory MEM (see FIG. 1) that stores the high-potential voltage EVDD setting information and the gate high voltage VGH setting information per luminance of image data. The information stored in the memory MEM (see FIG. 1) may be acquired and stored during optical compensation of the display device.

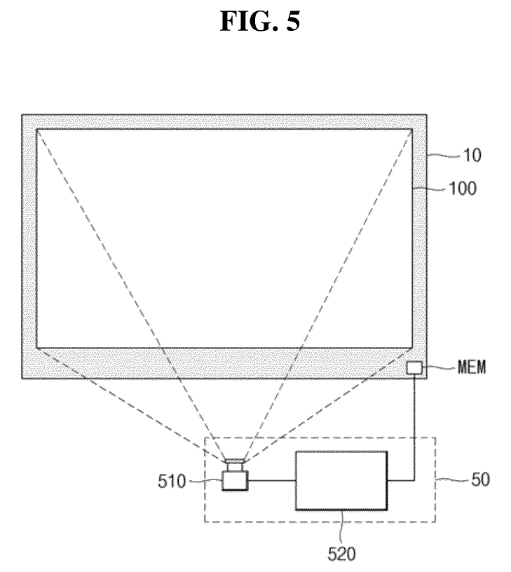

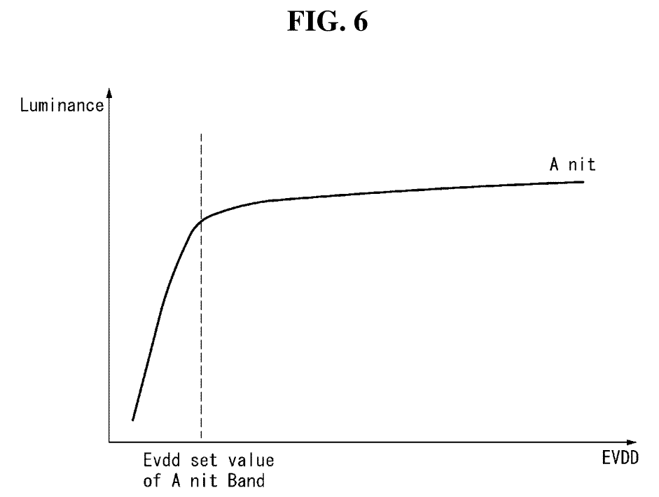

FIG. 5 is a schematic configuration diagram of an optical compensation system applied to the display device according to an embodiment of the present disclosure, and FIG. 6 is a diagram for describing information on setting the high-potential voltage EVDD per luminance.

Referring to FIG. 5, an optical compensation system 50 for optical compensation of the display device 10 may include a measurement device 510 and a compensation device 520.

The measurement device 510 may measure luminance, color coordinates, etc. of a test image displayed on the display panel 100.

The compensation device 520 may display a test image on the display panel 100, generate compensation data for image data compensation based on a result of measuring of luminance, color coordinates, etc. of the image measured through the measurement device 510, and store the compensation data in the memory MEM of the display device 10.

The compensation device 520 may acquire an optimal level of the high-potential voltage EVDD according to the luminance of the image and store the acquired level in the memory MEM of the display device 10. For example, referring to FIG. 6, the compensation device 520 may set a data voltage for reproducing target luminance (A nit), reproduce the same on the display panel 100, and measure luminance while varying the high-potential voltage EVDD at the corresponding data voltage as illustrated in FIG. 6. The compensation device 520 may determine a level of the high-potential voltage EVDD that may reproduce the corresponding data voltage by the target luminance. When the high-potential voltage EVDD at the lowest possible level that may reproduce the target luminance is set as the optimal level of the high-potential voltage EVDD, power consumption may be reduced at the time of reproducing a high-luminance image. In addition, the optimal high-potential voltage EVDD may be determined by applying various criteria. The compensation device 520 may store the high-potential voltage EVDD setting information for each luminance band in the memory MEM of the display device 10.

The compensation device 520 may store the gate high voltage VGH setting information in the memory MEM. The gate high voltage VGH setting information may be stored as an offset value applied to the voltage level of the high-potential voltage EVDD. The offset value may be set as a voltage level difference between the high-potential voltage EVDD that may keep the fifth transistor T5 in an off state and the gate high voltage VGH. For example, the offset value may be set to a positive value (a positive offset value) greater than the threshold voltage Vth of the fifth transistor T5.

Meanwhile, the threshold voltage Vth of the fifth transistor T5 may vary depending on the difference in process of the display panel 100. When the compensation device 520 can acquire information on the threshold voltage Vth of the transistor for each display panel 100, the offset value stored in the memory MEM may be stored as a different value depending on the information on the threshold voltage Vth of the corresponding display panel 100.

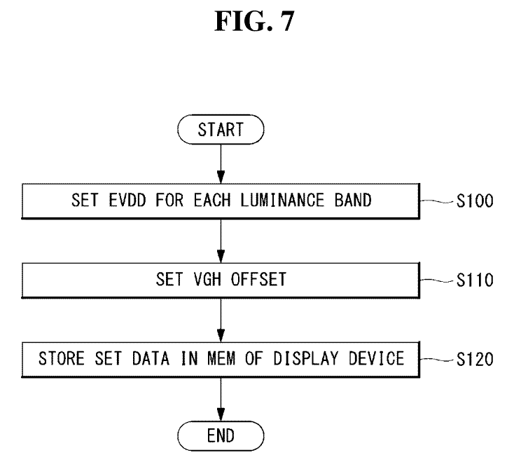

FIG. 7 is a flowchart of an optical compensation method applied to the display device according to an embodiment of the present disclosure.

Referring to FIG. 6 and FIG. 7, the optical compensation system 50 acquires an EVDD setting value for each luminance band through optical compensation (S100). The optical compensation system 50 sets a data voltage for reproducing luminance that may be reproduced on the display panel 100, for example, 255 Gray, reproduces the same on the display panel 100, and measures the luminance while varying the high-potential voltage EVDD, thereby determining the optimal level of the high-potential voltage EVDD that may reproduce 255 Gray. The level of the high-potential voltage EVDD for each luminance band may be set in the same manner.

The compensation device 520 generates the high-potential voltage EVDD setting information for the corresponding luminance band and offset value setting information for setting the gate high voltage VGH (S110). The offset value may be a preset value, or may be a value set according to the threshold voltage Vth information for each transistor of the display panel 100. The offset value may be set as a voltage level difference between the high-potential voltage EVDD and the gate high voltage VGH that may keep the fifth transistor T5 in an off state.

The compensation device 520 may store the high-potential voltage EVDD setting information and the gate high voltage VGH setting information per luminance in the memory MEM of the display device 10 (S120).

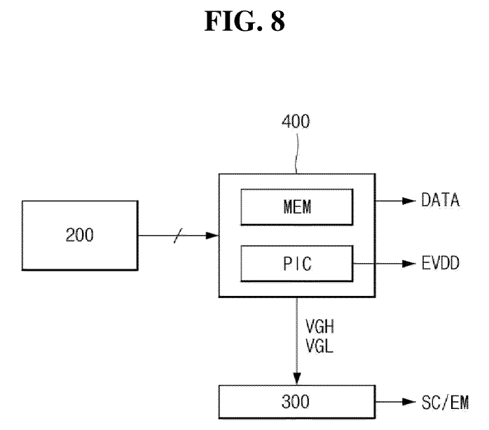

FIG. 8 is a diagram illustrating a configuration for controlling the gate high voltage VGH of the display device according to an embodiment of the present disclosure.

The controller 200 processes image data input from the outside to be appropriate for the size and resolution of the display panel 100 and supplies the data driver 400. Here, the controller 200 may provide luminance information of the image data to the data driver 400. The luminance information of the image data provided by the controller 200 may be, for example, an average luminance value of the image data for each frame, or a highest luminance value in the image data included in the image for each frame.

The data driver 400 may receive the luminance information of the image data from the controller 200. The data driver 400 may refer to the high-potential voltage EVDD setting information per luminance stored in the memory MEM to check the level of the high-potential voltage EVDD corresponding to the received luminance information of the image data. The data driver 400 may control a power control unit PIC so that the high-potential voltage EVDD is output according to the luminance band of the received image data. In addition, the data driver 400 may apply an offset value to the high-potential voltage EVDD according to the gate high voltage VGH setting information stored in the memory MEM to set the voltage level of the gate high voltage VGH. The power control unit PIC may supply the gate high voltage VGH and the gate low voltage VGL according to setting of the data driver 400 to the gate driver 300.

The gate driver 300 may generate the scan signal SC and the emission control signal EM that swing between the gate high voltage VGH and the gate low voltage VGL and supply the signals to the subpixels of the display panel 100.

The embodiment of FIG. 8 illustrates a case where the data driver 400 of the display device includes the memory MEM that stores the high-potential voltage EVDD setting information and the gate high voltage VGH setting information per luminance, and the power control unit PIC that outputs the high-potential voltage EVDD, the gate high voltage VGH, and the gate low voltage VGL. However, the control block of FIG. 8 is merely an example to aid understanding of the present disclosure, and each control block may be integrated or separated and configured in various ways. For example, the memory MEM that stores the high-potential voltage EVDD setting information and the gate high voltage VGH setting information per luminance may be built into the controller 200 or provided as a separate configuration in the display device 10. The power control unit PIC may be provided as a separate configuration independent from the data driver 400, and may be controlled by the controller 200 or the data driver 400.

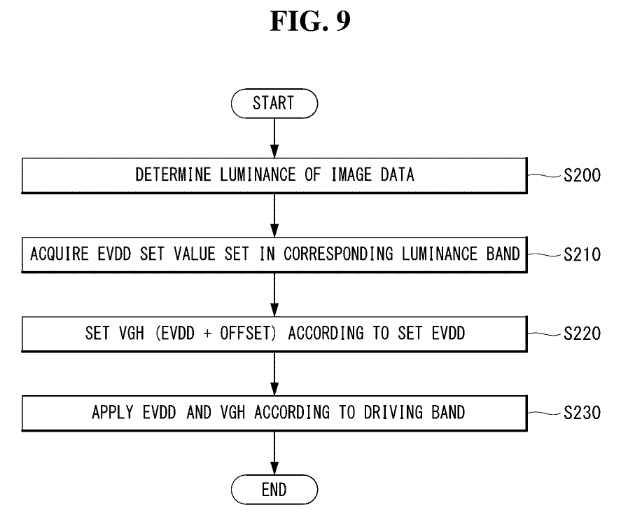

FIG. 9 is a flowchart of a method for controlling the gate high voltage VGH of the display device according to an embodiment of the present disclosure.

When image data is input to the display device, luminance of the image data is determined (S200).

The display device acquires the high-potential voltage EVDD setting value set for a corresponding luminance band based on pre-stored information (S210).

The display device sets a voltage level of the gate high voltage VGH by applying a pre-set offset value to the acquired high-potential voltage EVDD (S220).

The display device supplies the high-potential voltage EVDD and the gate high voltage VGH set for the luminance band to reproduce the image data (S230).

As described above, the display device according to the embodiment of the present disclosure may reduce power consumption when reproducing a high-luminance image by variably controlling the voltage level of the high-potential voltage EVDD according to the luminance of the image data. In addition, by setting the gate high voltage VGH based on the variably controlled high-potential voltage EVDD, the subpixel may be controlled without using an excessively high voltage, thereby maximizing the power consumption reduction effect.

The embodiments of the present disclosure have the following effects.

The display device according to the embodiments of the present disclosure may reduce power consumption by variably controlling the high-potential voltage EVDD according to the luminance of the input image.

The display device according to the embodiments of the present disclosure may maximize the power consumption reduction effect by variably setting the gate high voltage VGH of the gate signal based on the variably set high-potential voltage EVDD, thereby preventing unnecessary power consumption for driving the subpixels.

The effects of the present disclosure are not limited to those illustrated above, and the present disclosure encompasses a wider variety of effects.

Even though the embodiments of the present disclosure have been described in more detail with reference to the attached drawings, the present disclosure is not necessarily limited to these embodiments, and various modifications may be made without departing from the technical idea of the present disclosure. Accordingly, the embodiments disclosed in the present disclosure are not intended to limit the technical idea of the present disclosure but to describe the technical idea, and the scope of the technical idea of the present disclosure is not limited by these embodiments. Therefore, it should be understood that the embodiments described above are illustrative and not restrictive in all respects. The scope of protection of the present disclosure should be interpreted by the claims, and all technical ideas within a scope equivalent thereto should be interpreted as being included in the scope of rights of the present disclosure.

What is claimed is:

1. A display device comprising:
a display panel having subpixels formed on the display panel, each of the subpixels including a driving transistor and at least one light emission control transistor, the driving transistor is configured to generate a driving current for driving a light emitting element, and the at least one light emission control transistor are configured to apply a high-potential voltage to the driving transistor;
a gate driver configured to receive a gate high voltage and a gate low voltage, wherein the gate driver is configured to output a gate signal for controlling the at least one light emission control transistor included in the subpixels; and
a power supply configured to supply a gate high voltage set according to a voltage level of the high-potential voltage to the gate driver.

2. The display device according to claim 1, wherein a difference between the high-potential voltage and the gate high voltage is maintained constant based on an offset value.

3. The display device according to claim 2, further comprising a memory configured to store the offset value and high-potential voltage setting information per luminance of image data.

4. The display device according to claim 3, further comprising:
a controller configured to generate luminance information of the image data; and
a data driver configured to receive the luminance information from the controller, and the data driver is configured to control the power supply so that a high-potential voltage corresponding to the luminance information is output according to the high-potential voltage setting information per luminance stored in the memory.

5. The display device according to claim 4, wherein the data driver sets the gate high voltage by applying the offset value to the high-potential voltage corresponding to the luminance information, and the data driver controls the power supply so that a set gate high voltage is supplied to the data driver.

6. The display device according to claim 2, wherein one of the at least one light emission control transistor comprises:
a gate electrode configured to receive the gate signal;
a first electrode configured to receive the high-potential voltage; and
a second electrode connected to a source electrode of the driving transistor.

7. The display device according to claim 6, wherein the at least one light emission control transistor comprises a P-type thin film transistor.

8. The display device according to claim 6, wherein the at least one light emission control transistor is turned off by receiving the gate high voltage of the gate signal.

9. The display device according to claim 8, wherein the offset value is set based on a positive offset value greater than a threshold voltage of the at least one light emission control transistor and the high-potential voltage.

10. A method of driving a display device comprising a display panel having subpixels formed on the display panel, each of the subpixels including a driving transistor and at least one light emission control transistor, the driving transistor configured to generate a driving current for driving a light emitting element, and the at least one light emission control transistor configured to apply a high-potential voltage to the driving transistor, the method comprising:
setting a voltage level of the high-potential voltage according to input image luminance;
setting a level of a gate high voltage by applying an offset value to the voltage level of the high-potential voltage; and
generating an emission control signal that swings between the gate high voltage and a gate low voltage to output the generated emission control signal to the display panel.

11. The method according to claim 10, wherein one light emission control transistor of the at least one light emission control transistor comprises:
a gate electrode configured to receive a gate signal;
a first electrode configured to receive the high-potential voltage; and
a second electrode connected to a source electrode of the driving transistor.

12. The method according to claim 11, wherein the at least one light emission control transistor comprises a P-type thin film transistor.

13. The method according to claim 11, wherein setting the level of the gate high voltage comprises setting a voltage level of the gate high voltage so that a voltage difference between the high-potential voltage and the gate high voltage is set to a voltage level allowing the one light emission control transistor to be turned off.

14. The method according to claim 10, wherein the offset value is set based on a positive offset value greater than a threshold voltage of the at least one light emission control transistor and the high-potential voltage.
